(19) United States
(12) Patent Application Publication
(10) Pub. No.: US 2014/0119058 A1
(43) Pub. Date: May 1, 2014

(54) POWER VOLTAGE CONVERSION SYSTEM FOR CONTROLLER INTEGRATED CIRCUIT

(71) Applicant: CHICONY POWER TECHNOLOGY CO., LTD., New Taipei City (TW)

(72) Inventors: Keng-Yi CHOU, New Taipei City (TW); Chia-Chieh LIN, New Taipei City (TW)

(73) Assignee: Chicony Power Technology Co., Ltd., New Taipei City (TW)

(21) Appl. No.: 13/664,135

(22) Filed: Oct. 30, 2012

(51) Int. Cl. H02M 3/335

(52) U.S. Cl. 363/16

(57) ABSTRACT

A power voltage conversion system for a controller integrated circuit includes a DC-to-DC converter and a controller IC. The DC-to-DC converter receivers an external DC voltage and the DC-to-DC converter at least has an inductance element and a switch element. The inductance element has at least one first winding and one second winding and the first winding is connected to the second winding in series. The controller IC is electrically connected to the inductance element and the switch element. The external DC voltage is converted into at least one power voltage according to a turn ratio between the first winding and the second winding, thus supplying power to the controller IC to control the switch element.

### BACKGROUND

1. Technical Field

The present disclosure relates generally to a power voltage conversion system for a controller integrated circuit, and more particularly to a power voltage conversion system for a controller integrated circuit applied to a DC-to-DC converter.

2. Description of Related Art

In response to declining prices of the LED (light-emitting diode) products, the price of the LED drivers is relatively decreased. In low-cost and high-efficiency considerations, most DC-to-DC converters, such as the buck converter, boost converter, and buck-boost converter need to use an auxiliary winding to provide the required power voltage (usually labeled Vcc) for supplying power to the controller IC 20A.

Reference is made to FIG. 1 which is a circuit diagram of a producing a power voltage by a prior art auxiliary winding for supplying power to a controller IC. The required power voltage Vcc of the controller IC 20A is provided by an additional auxiliary winding Wa of a transformer L. According to a turn ratio of the transformer L, a DC input voltage Vin is converted into the power voltage Vcc to supply power to the controller IC 20A, thus producing a DC output voltage Vout to provide the required voltage for driving a LED string 40A.

In general, the inductor is designed as transformer-type structure to additionally provide the auxiliary winding Wa. However, the cost of the transformer is higher than other components and is in a large proportion of the total costs. Hence, the industry mostly uses the DR choke to replace the transformer so as to reduce the cost of the transformer. Unlike the transformer, however, the general DR choke cannot provide an additional auxiliary winding to provide the power voltage. In addition, the power voltage of the controller IC 20A is usual supplied by building an output voltage. However, a very large disadvantage of the application is that the output voltage cannot to be able too high. That is, the too-high voltage would cause the LED driver to produce high temperature and reduce efficiency because of the increasing current.

Accordingly, it is desirable to provide a power voltage conversion system for a controller integrated circuit that an inductor element of the DC-to-DC converter (regardless of the buck, boost, or buck-boost convert) is designed to the two-winding type without additional auxiliary winding so that the inductor voltage is divided to provide the power voltage for supplying power to the controller integrated circuit, thus minimizing the circuit design, reducing circuit elements and costs, and simplifying circuit process.

### SUMMARY

An object of the invention is to provide a power voltage conversion system for a controller integrated circuit to solve the above-mentioned problems. Accordingly, the power voltage conversion system includes a DC-to-DC converter and a controller integrated circuit. The DC-to-DC converter receives an external DC voltage and the DC-to-DC converter has an inductor element and a switch element. The inductor element has at least one first winding and one second winding, the first winding is connected to the second winding in series. The controller integrated circuit is electrically connected to the inductor element and the switch element. The external DC voltage is converted into at least one power voltage by a turn ratio between the first winding and the second winding so that the power voltage is configured to supply power to the controller integrated circuit, thus controlling the switch element.

It is to be understood that both the foregoing general description and the following detailed description are exemplary, and are intended to provide further explanation of the invention as claimed. Other advantages and features of the invention will be apparent from the following description, drawings and claims.

### BRIEF DESCRIPTION OF DRAWINGS

The features of the present disclosure believed to be novel are set forth with particularity in the appended claims. The present disclosure itself, however, may be best understood by reference to the following detailed description of the present disclosure, which describes an exemplary embodiment of the present disclosure, taken in conjunction with the accompanying drawings, in which:

FIG. 1 is a circuit diagram of a producing a power voltage by a prior art auxiliary winding for supplying power to a controller IC;

FIG. 2 is a schematic view of dividing voltage of an inductor element of a power voltage conversion system according to the present disclosure;

FIG. 3 is a schematic block diagram of the power voltage conversion system according to the present disclosure;

FIG. 4A is a schematic circuit diagram of turning on a switch element of the power voltage conversion system according to the present disclosure;

FIG. 4B is a schematic circuit diagram of turning off the switch element of the power voltage conversion system according to the present disclosure;

FIG. 4C is a schematic view of combining a current waveform and a voltage waveform of the inductor element according to the present disclosure;

FIG. 5 is a circuit diagram of the power voltage conversion system for a controller integrated circuit according to a first embodiment of the present disclosure;

FIG. 6 is a circuit diagram of the power voltage conversion system for the controller integrated circuit according to a second embodiment of the present disclosure;

FIG. 7 is a circuit diagram of the power voltage conversion system for the controller integrated circuit according to a third embodiment of the present disclosure;

FIG. 8 is a circuit diagram of the power voltage conversion system for the controller integrated circuit according to a fourth embodiment of the present disclosure; and

FIG. 9 is a circuit diagram of the power voltage conversion system for the controller integrated circuit according to a fifth embodiment of the present disclosure.

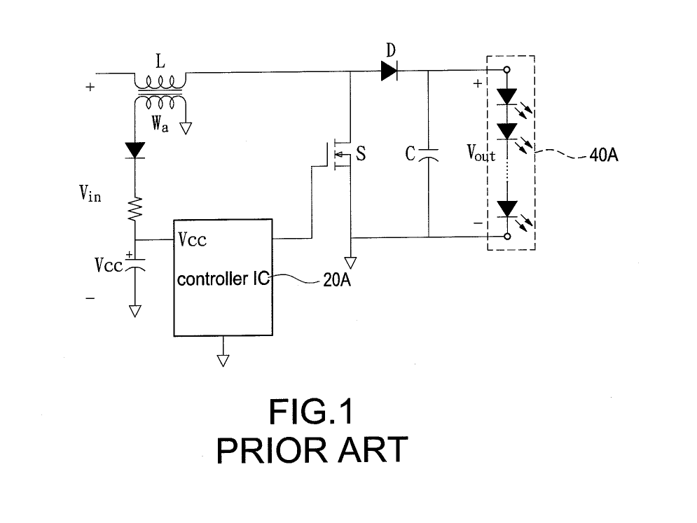

### DETAILED DESCRIPTION

Reference will now be made to the drawing figures to describe the present invention in detail.

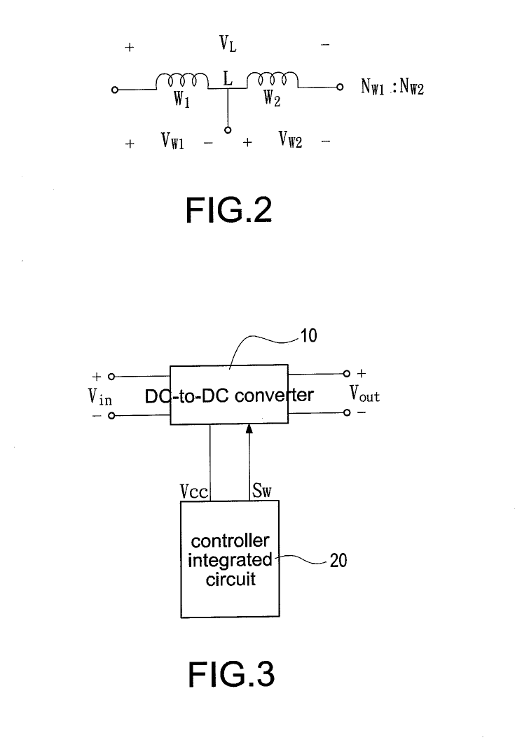

Reference is made to FIG. 2 which is a schematic view of dividing voltage of an inductor element of a power voltage conversion system according to the present disclosure. The inductor element L has a first winding w1 and a second winding w2. The first winding w1 has a first turn number Nw1 and the second winding w2 has a second turn number Nw2, that is, a turn ratio between the first winding w1 and the second winding w2 is Nw1:Nw2. Hence, when a voltage across the inductor element L is an inductor voltage VL, a first voltage Vw1 across the first winding w1 and a second voltage Vw2 across the second winding w2 are represent as follows:

$${V}_{w 1} = {V}_{L} \times \frac{{N}_{w 1}}{{N}_{w 1} + {N}_{w 2}}$$

$${V}_{w 2} = {V}_{L} \times \frac{{N}_{w 2}}{{N}_{w 1} + {N}_{w 2}}$$

Especially, the two in-series windings of the inductor element L is only exemplified but is not intended to limit the scope of the disclosure. Also, two inductors connected in series also can be used to form the structure of two in-series windings.

Reference is made to FIG. 3 which is a schematic block diagram of the power voltage conversion system according to the present disclosure. The power voltage conversion system includes a DC-to-DC converter 10 and a controller integrated circuit 20. The DC-to-DC converter 10 receives an external DC voltage Vin and the DC-to-DC converter 10 at least has an inductor element and a switch element (detailed description below). The inductor element has at least one first winding and a second winding and the first winding is connected to the second winding in series. The controller integrated circuit 20 is electrically connected to the inductor element and the switch element of the DC-to-DC converter 10. In particular, the external DC voltage Vin is converted into at least one power voltage Vcc by the turn ratio between the first winding and the second winding so that the power voltage Vcc is provided to supply power to the controller integrated circuit 20, thus producing a switch control signal Sw to control the switch element. In addition, a DC output voltage Vout is outputted from the DC-to-DC converter 10 can be used to drive LED strings or other applications. However, the embodiments are only exemplified but are not intended to limit the scope of the disclosure.

Especially, the DC-to-DC converter 10 can be designed in different common topologies, such as the buck converter, the boost converter, or the buck-boost converter. Therefore, the different DC-to-DC converters will be described in detail hereinafter with different figures as follows.

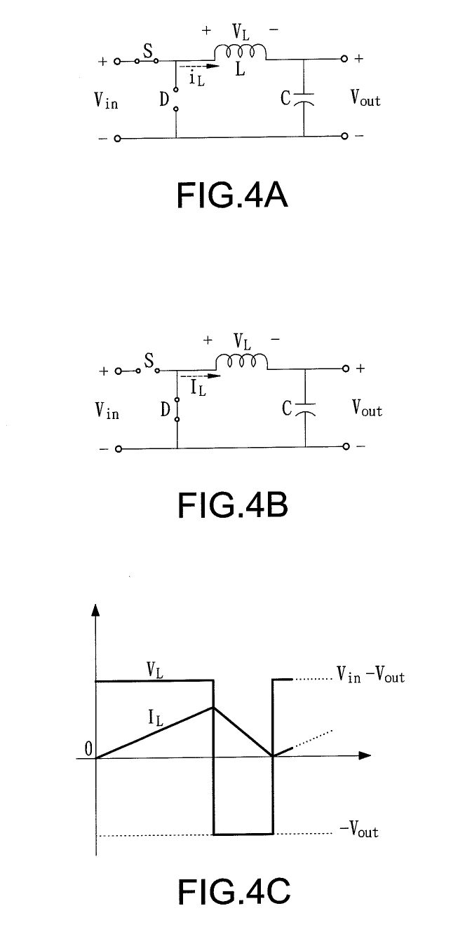

Before describing in detail these common DC-to-DC converter topologies, the buck converter is exemplified for demonstration of the inductor element according to the voltage and the current thereof. Reference is made to FIG. 4A and FIG. 4B which are schematic circuit diagrams of turning on and turning off a switch element of the power voltage conversion system according to the present disclosure, respectively. In addition, reference is made to FIG. 4C which is a schematic view of combining a current waveform and a voltage waveform of the inductor element according to the present disclosure. In the FIG. 4A, when the switch element S is turned on, the diode element D is turned off due to the reverse-bias voltage so that electrical energy is transferred from the power source to the inductor element L and back-end loads. At this time, the magnitude of the inductor voltage VL of the inductor element L is: VL=Vin−Vout. In the FIG. 4B, when the switch element S is turned off, the diode element D is turned on due to the forward-bias voltage so that the current of the inductor element L flows through the diode element D, thus transferring the stored energy from the inductor element L to the back-end loads. At this time, the magnitude of the inductor voltage VL of the inductor element L is: VL=−Vout. Accordingly, a current waveform and a voltage waveform of the inductor element L during a complete charging and discharging cycle are shown in the FIG. 4C. Especially, it is assumed that the inductor element L is operated under the continuous conduction mode (CCM). In particular, the switch element S can be a MOSFET. However, the embodiment is only exemplified but is not intended to limit the scope of the disclosure.

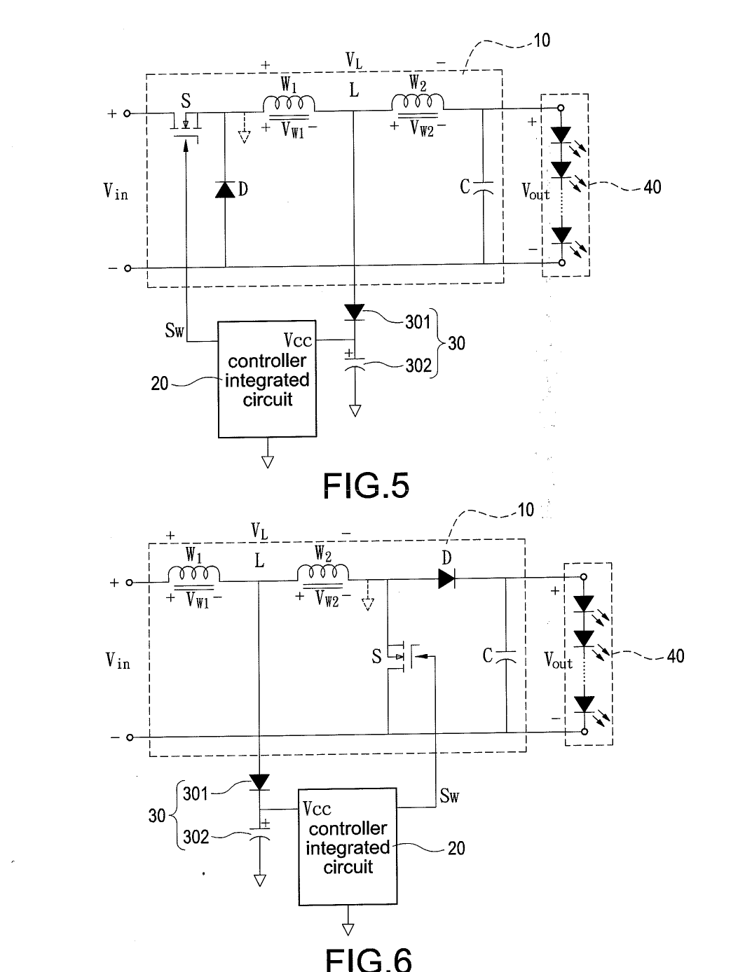

Reference is made to FIG. 5 which is a circuit diagram of the power voltage conversion system for a controller integrated circuit according to a first embodiment of the present disclosure. In this embodiment, the DC-to-DC converter 10 is a buck converter for an example as described below. The buck converter 10 has a switch element S, a diode element D, an inductor element L, and a capacitor element C. Especially, the inductor element L is substantially equivalent to the inductor element L shown in the FIG. 2. The inductor element L has a first winding w1 with a first turn number Nw1 and a second winding w2 with a second turn number Nw2. The buck converter 10 receives an external DC voltage Vin and converts the external DC voltage Vin into a DC output voltage Vout to provide the required voltage for driving a LED string 40. In addition, the switch element S of the buck converter 10 is controlled by a switch control signal Sw produced from a controller integrated circuit 20. In particular, the controller integrated circuit 20 can be a PWM controller and the switch control signal Sw can be a PWM signal.

Furthermore, the power voltage conversion system further includes a rectifying circuit 30. In this embodiment, the rectifying circuit 30 has a rectifying diode 301 and a capacitor 302. However, the embodiment is only exemplified but is not intended to limit the scope of the disclosure. The first winding w1 is connected to the second winding w2 in series at a connection point and an anode of the rectifying diode 301 is connected to the connection point. According to the turn ratio between the first winding w1 and the second winding w2, the inductor voltage VL is divided into a first voltage Vw1 and a second voltage Vw2 which are across the first winding w1 and the second winding w2, respectively. In this embodiment, the first voltage Vw1 is provided as a power voltage Vcc for supplying power to the controller integrated circuit 20 to control the switch element S.

For convenient explanation, reasonable assumption data are exemplified for further demonstration of dividing the inductor voltage VL for the power voltage Vcc. It is assumed that the inductor voltage VL is equal to 156 volts across the inductor element L by converting the external DC voltage Vin by the buck converter 10. Hence, the turn ratio between the first turn number Nw1 and the second turn number Nw2 can be designed to 1:12 so that the first voltage Vw1 is 12 volts and the second voltage Vw2 is 144 volts, respectively. In this embodiment, the first voltage Vw1 across the first winding w1 is used as the power voltage Vcc for supplying power to the controller integrated circuit 20. That is, when the switch element S is turned on, the capacitor 302 is charged to be in an energy-storing condition so that the power voltage Vcc is built across the capacitor 302. On the contrary, when the switch element S is turned off, the capacitor 302 is discharged to be in an energy-releasing condition. However, the voltage across the capacitor 302 is sufficient to provide the required power voltage Vcc for supplying power to the controller integrated circuit 20. Accordingly, during a complete charging and discharging cycle, the inductor voltage VL can be divided to produce the power voltage Vcc for supplying power to the controller integrated circuit 20 to control the switch element S, thus outputting the DC output voltage Vout to drive the LED string 40. Especially, the buck converter 10 of the power voltage conversion system can be implemented in either the continuous conduction mode (CCM) or the discontinuous condition mode (DCM).

Reference is made to FIG. 6 which is a circuit diagram of the power voltage conversion system for the controller integrated circuit according to a second embodiment of the present disclosure. In this embodiment, the DC-to-DC converter 10 is a boost converter for an example as described below. The boost converter 10 has a switch element S, a diode element D, an inductor element L, and a capacitor element C. Especially, the inductor element L is substantially equivalent to the inductor element L shown in the FIG. 2. The inductor element L has a first winding w1 with a first turn number Nw1 and a second winding w2 with a second turn number Nw2. The boost converter 10 receives an external DC voltage Vin and converts the external DC voltage Vin into a DC output voltage Vout to provide the required voltage for driving a LED string 40. In addition, the switch element S of the boost converter 10 is controlled by a switch control signal Sw produced from a controller integrated circuit 20.

Furthermore, the power voltage conversion system further includes a rectifying circuit 30. In this embodiment, the rectifying circuit 30 has a rectifying diode 301 and a capacitor 302. The first winding w1 is connected to the second winding w2 in series at a connection point and an anode of the rectifying diode 301 is connected to the connection point. According to the turn ratio between the first winding w1 and the second winding w2, the inductor voltage VL is divided into a first voltage Vw1 and a second voltage Vw2 which are across the first winding w1 and the second winding w2, respectively. In this embodiment, the second voltage Vw2 is provided as a power voltage Vcc for supplying power to the controller integrated circuit 20 to control the switch element S.

It is assumed that the inductor voltage VL is equal to 156 volts across the inductor element L by converting the external DC voltage Vin by the boost converter 10. Hence, the turn ratio between the first turn number Nw1 and the second turn number Nw2 can be designed to 12:1 so that the first voltage Vw1 is 144 volts and the second voltage Vw2 is 12 volts, respectively. In this embodiment, the second voltage Vw2 across the second winding w2 is used as the power voltage Vcc for supplying power to the controller integrated circuit 20. That is, when the switch element S is turned on, the capacitor 302 is charged to be in an energy-storing condition so that the power voltage Vcc is built across the capacitor 302. On the contrary, when the switch element S is turned off, the capacitor 302 is discharged to be in an energy-releasing condition. However, the voltage across the capacitor 302 is sufficient to provide the required power voltage Vcc for supplying power to the controller integrated circuit 20. Accordingly, during a complete charging and discharging cycle, the inductor voltage VL can be divided to produce the power voltage Vcc for supplying power to the controller integrated circuit 20 to control the switch element S, thus outputting the DC output voltage Vout to drive the LED string 40. Especially, the boost converter 10 of the power voltage conversion system can be implemented in either the continuous conduction mode (CCM) or the discontinuous condition mode (DCM).

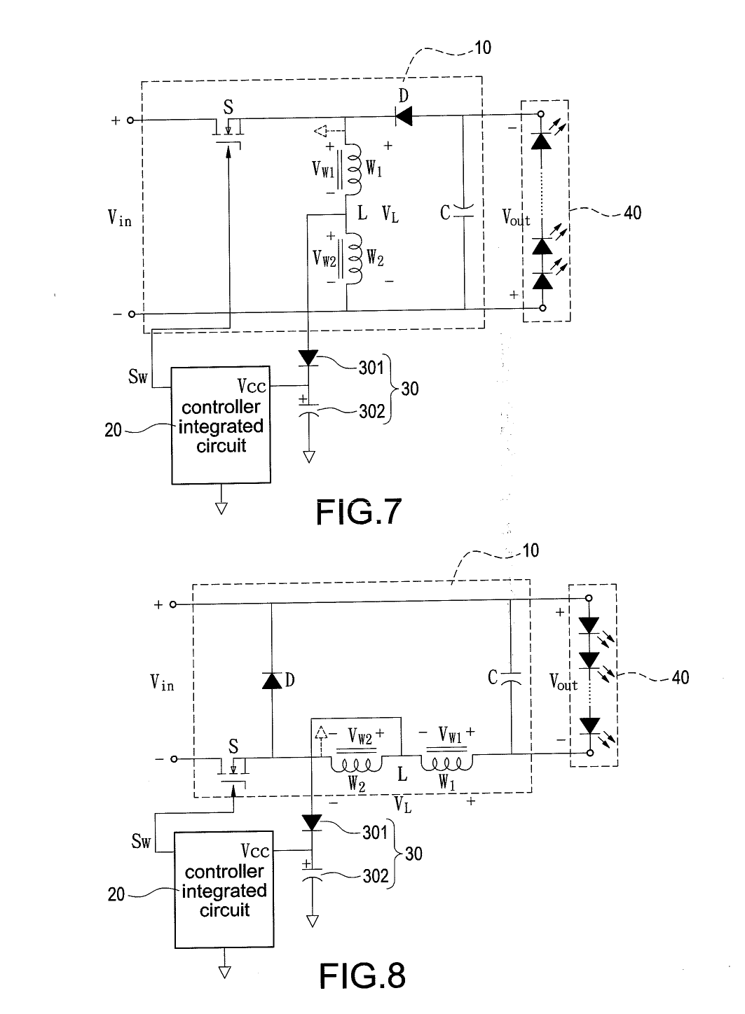

Reference is made to FIG. 7 which is a circuit diagram of the power voltage conversion system for the controller integrated circuit according to a third embodiment of the present disclosure. In this embodiment, the DC-to-DC converter 10 is a buck-boost converter for an example as described below. The buck-boost converter 10 has a switch element S, a diode element D, an inductor element L, and a capacitor element C. Especially, the inductor element L is substantially equivalent to the inductor element L shown in the FIG. 2. The inductor element L has a first winding w1 with a first turn number Nw1 and a second winding w2 with a second turn number Nw2. The buck-boost converter 10 receives an external DC voltage Vin and converts the external DC voltage Vin into a DC output voltage Vout to provide the required voltage for driving a LED string 40. In addition, the switch element S of the buck-boost converter 10 is controlled by a switch control signal Sw produced from a controller integrated circuit 20.

Furthermore, the power voltage conversion system further includes a rectifying circuit 30. In this embodiment, the rectifying circuit 30 has a rectifying diode 301 and a capacitor 302. The first winding w1 is connected to the second winding w2 in series at a connection point and an anode of the rectifying diode 301 is connected to the connection point. According to the turn ratio between the first winding w1 and the second winding w2, the inductor voltage VL is divided into a first voltage Vw1 and a second voltage Vw2 which are across the first winding w1 and the second winding w2, respectively. In this embodiment, the first voltage Vw1 is provided as a power voltage Vcc for supplying power to the controller integrated circuit 20 to control the switch element S.

It is assumed that the inductor voltage VL is equal to 156 volts across the inductor element L by converting the external DC voltage Vin by the buck-boost converter 10. Hence, the turn ratio between the first turn number Nw1 and the second turn number Nw2 can be designed to 1:12 so that the first voltage Vw1 is 12 volts and the second voltage Vw2 is 144 volts, respectively. In this embodiment, the first voltage Vw1 across the first winding w1 is used as the power voltage Vcc for supplying power to the controller integrated circuit 20. That is, when the switch element S is turned on, the capacitor 302 is charged to be in an energy-storing condition so that the power voltage Vcc is built across the capacitor 302. On the contrary, when the switch element S is turned off, the capacitor 302 is discharged to be in an energy-releasing condition. However, the voltage across the capacitor 302 is sufficient to provide the required power voltage Vcc for supplying power to the controller integrated circuit 20. Accordingly, during a complete charging and discharging cycle, the inductor voltage VL can be divided to produce the power voltage Vcc for supplying power to the controller integrated circuit 20 to control the switch element S, thus outputting the DC output voltage Vout to drive the LED string 40. Especially, the buck-boost converter 10 of the power voltage conversion system can be implemented in either the continuous conduction mode (CCM) or the discontinuous condition mode (DCM).

Reference is made to FIG. 8 which is a circuit diagram of the power voltage conversion system for the controller integrated circuit according to a fourth embodiment of the present disclosure. The DC-to-DC converter 10 disclosed in the fourth embodiment and that disclosed in the first embodiment are both a buck converter. Hence, the detail description is omitted here for conciseness. However, the major difference between the two embodiments is that the switch element S and the inductor element L disclosed in the first embodiment are connected to a high side of the buck converter, whereas the switch element S and the inductor element L disclosed in the fourth embodiment are connected to a low side of the buck converter. In this embodiment, the second voltage Vw2 is provided as a power voltage Vcc for supplying power to the controller integrated circuit 20. It is assumed that the inductor voltage VL is equal to 156 volts across the inductor element L by converting the external DC voltage Vin by the buck converter 10. Hence, the turn ratio between the first turn number Nw1 and the second turn number Nw2 can be designed to 12:1 so that the first voltage Vw1 is 144 volts and the second voltage Vw2 is 12 volts, respectively. In this embodiment, the second voltage Vw2 across the second winding w2 is used as the power voltage Vcc for supplying power to the controller integrated circuit 20. That is, when the switch element S is turned on, the capacitor 302 is charged to be in an energy-storing condition so that the power voltage Vcc is built across the capacitor 302. On the contrary, when the switch element S is turned off, the capacitor 302 is discharged to be in an energy-releasing condition. However, the voltage across the capacitor 302 is sufficient to provide the required power voltage Vcc for supplying power to the controller integrated circuit 20. Accordingly, during a complete charging and discharging cycle, the inductor voltage VL can be divided to produce the power voltage Vcc for supplying power to the controller integrated circuit 20 to control the switch element S, thus outputting the DC output voltage Vout to drive the LED string 40. Especially, the buck converter 10 of the power voltage conversion system can be implemented in either the continuous conduction mode (CCM) or the discontinuous condition mode (DCM).

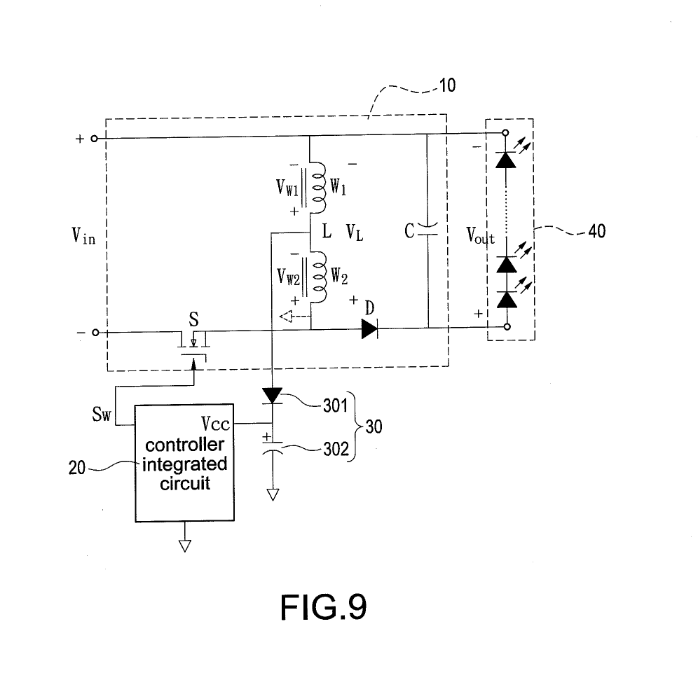

Reference is made to FIG. 9 which is a circuit diagram of the power voltage conversion system for the controller integrated circuit according to a fifth embodiment of the present disclosure. The DC-to-DC converter 10 disclosed in the fifth embodiment and that disclosed in the second embodiment are both a boost converter. Hence, the detail description is omitted here for conciseness. However, the major difference between the two embodiments is that the switch element S and the inductor element L disclosed in the second embodiment are connected to a high side of the boost converter, whereas the switch element S and the inductor element L disclosed in the fifth embodiment are connected to a low side of the boost converter. In this embodiment, the second voltage Vw2 is provided as a power voltage Vcc for supplying power to the controller integrated circuit 20. It is assumed that the inductor voltage VL is equal to 156 volts across the inductor element L by converting the external DC voltage Vin by the boost converter 10. Hence, the turn ratio between the first turn number Nw1 and the second turn number Nw2 can be designed to 12:1 so that the first voltage Vw1 is 144 volts and the second voltage Vw2 is 12 volts, respectively. In this embodiment, the second voltage Vw2 across the second winding w2 is used as the power voltage Vcc for supplying power to the controller integrated circuit 20. That is, when the switch element S is turned on, the capacitor 302 is charged to be in an energy-storing condition so that the power voltage Vcc is built across the capacitor 302. On the contrary, when the switch element S is turned off, the capacitor 302 is discharged to be in an energy-releasing condition. However, the voltage across the capacitor 302 is sufficient to provide the required power voltage Vcc for supplying power to the controller integrated circuit 20. Accordingly, during a complete charging and discharging cycle, the inductor voltage VL can be divided to produce the power voltage Vcc for supplying power to the controller integrated circuit 20 to control the switch element S, thus outputting the DC output voltage Vout to drive the LED string 40. Especially, the boost converter 10 of the power voltage conversion system can be implemented in either the continuous conduction mode (CCM) or the discontinuous condition mode (DCM).

In conclusion, the present disclosure has following advantages:

1. The inductor element of the DC-to-DC converter (regardless of the buck, boost, or buck-boost convert) is designed to the two-winding type without additional auxiliary winding so that the inductor voltage VL is divided to provide the power voltage Vcc for supplying power to the controller integrated circuit 20, thus minimizing the circuit design, reducing circuit elements and costs, and simplifying circuit process;

2. The DC-to-DC converter 10 of the power voltage conversion system can be implemented in either the continuous conduction mode (CCM) or the discontinuous condition mode (DCM); and

3. The switch element S and the inductor element L can be implemented in either the high side or the low side of the DC-to-DC converter 10.

Although the present disclosure has been described with reference to the preferred embodiment thereof, it will be understood that the invention is not limited to the details thereof. Various substitutions and modifications have been suggested in the foregoing description, and others will occur to those of ordinary skill in the art. Therefore, all such substitutions and modifications are intended to be embraced within the scope of the invention as defined in the appended claims.

What is claimed is:

1. A power voltage conversion system for a controller integrated circuit, comprising:
a DC-to-DC converter receiving an external DC voltage, at least comprising:
an inductor element having at least one a first winding and a second winding, the first winding connected to the second winding in series; and
a switch element; and
a controller integrated circuit electrically connected to the inductor element and the switch element;
wherein the external DC voltage is converted into at least one power voltage by a turn ratio between the first winding and the second winding so that the power voltage is configured to supply power to the controller integrated circuit, thus controlling the switch element.

2. The power voltage conversion system in claim 1, wherein the DC-to-DC converter is a buck converter, the first winding is connected to the second winding in series at a connection point; wherein the external DC voltage is converted into an inductor voltage across the inductor element by the buck converter, the inductor voltage is converted into the power voltage according to a turn ratio between the first winding and the second winding and the power voltage is outputted to supply power to the controller integrated circuit via the connection point.

3. The power voltage conversion system in claim 1, wherein the DC-to-DC converter is a boost converter, the first winding is connected to the second winding in series at a connection point; wherein the external DC voltage is converted into an inductor voltage across the inductor element by the boost converter, the inductor voltage is converted into the power voltage according to a turn ratio between the first winding and the second winding and the power voltage is outputted to supply power to the controller integrated circuit via the connection point.

4. The power voltage conversion system in claim 1, wherein the DC-to-DC converter is a buck-boost converter, the first winding is connected to the second winding in series at a connection point; wherein the external DC voltage is converted into an inductor voltage across the inductor element by the buck-boost converter, the inductor voltage is converted into the power voltage according to a turn ratio between the first winding and the second winding and the power voltage is outputted to supply power to the controller integrated circuit via the connection point.

5. The power voltage conversion system in claim 1, wherein the power voltage conversion system further comprises a rectifying circuit, the rectifying circuit is connected to the first winding and the second winding to receive the power voltage and is configured to supply power to the controller integrated circuit.

6. The power voltage conversion system in claim 1, wherein the inductor element and the switch element are connected to a high side or a low side of the DC-to-DC converter.

7. The power voltage conversion system in claim 1, wherein the DC-to-DC converter is operated under a continuous conduction mode or a discontinuous condition mode.

8. The power voltage conversion system in claim 1, wherein the controller integrated circuit is a PWM controller and the controller integrated circuit produces a PWM signal to control the switch element.

9. The power voltage conversion system in claim 1, wherein the inductor element is a DR choke.

10. The power voltage conversion system in claim 1, wherein the two-winding structure of the inductor element is formed by two in-series inductors.
